(19) United States
(12) Patent Application Publication
(10) Pub. No.: US 2005/0140268 A1
(43) Pub. Date: Jun. 30, 2005

(54) Electron emission device

(76) Inventors: Byong-Gon Lee, Suwon-si (KR); Sang-Ho Jeon, Suwon-si (KR)

Correspondence Address: CHRISTIE, PARKER & HALE, LLP, PO BOX 7068, PASADENA, CA, 91109-7068, US

(21) Appl. No.: 10/927,177

(22) Filed: Aug. 25, 2004

(30) Foreign Application Priority Data
Dec. 27, 2003 (KR) 2003-0098109

(51) Int. Cl. H01J 1/62; H01J 63/04

(52) U.S. Cl. 313/495

(57) ABSTRACT

An electron emission device includes first and second substrates facing each other with a distance, and first and second electrodes formed on the first substrate. Electron emission regions contact the second electrodes, and are located corresponding to pixel regions established on the first substrate. A grid electrode is disposed between the first and the second substrates, and has electron beam passage holes corresponding to the respective electron emission regions. With the electron emission device, the positional relation of the electron emission region to the beam passage hole of the grid electrode is optimally made to thereby enhance the screen brightness and the color representation.

### CROSS REFERENCE TO RELATED APPLICATION

This application claims priority to and the benefit of Korea Patent Application No. 2003-0098109 filed on Dec. 27, 2003 in the Korean Intellectual Property Office, the content of which is incorporated herein by reference.

### BACKGROUND OF THE INVENTION

(a) Field of the Invention

The present invention relates to an electron emission device, and in particular, to an electron emission device which optimally establishes the positional relation of an electron emission region to an electron beam passage hole of a grid electrode to thereby enhance the screen brightness and the color representation.

(b) Description of Related Art

Generally, an electron emission device is a flat panel display which makes the electrons emitted from the electron emission sources formed at a first substrate collide against phosphor layers formed at a second substrate, thereby emitting light and displaying a desired image. Hot or cold cathodes may be used as the electron emission sources.

Among the electron emission devices using the cold cathodes there are field emitter array (FEA) types, metal-insulator-metal (MIM) types, metal-insulator-semiconductor (MIS) types, and surface conduction electron-emitting (SCE) types.

The MIM and the MIS electron emission devices have an electron emission region with an MIM structure, and an electron emission region with an MIS structure, respectively. When voltage is applied to two metallic layers or to a metallic layer and a semiconductor layer, with an insulating layer interposed therebetween, the emitted electrons run and accelerate from the metallic or semiconductor layer at a high electric potential toward the metallic layer at a low electric potential.

With the SCE electron emission device, first and second electrodes are formed on a cathode substrate parallel to each other, and a conductive layer is formed on the first and second electrodes, respectively. An electron emission region is formed between the conductive layers with micro cracks, and the current flow is made parallel to the surface of the electron emission region, thereby emitting electrons.

With the FEA electron emission device, the electron emission region is formed on the cathode electrode with a metallic material such as molybdenum (Mo), or a carbonaceous material such as graphite, or nano-sized material such as carbon nano tube (CNT), graphite nano fiber (GNT), and nano-wire. A gate electrode is formed over the electron emission region. When an electric field is applied to the electron emission region due to the voltage difference between the cathode electrode and the gate electrode, electrons are emitted from the electron emission region.

As described above, with the electron emission device using the cold cathodes, the first substrate basically has an electron emission region, and driving electrodes for controlling the electron emission of the electron emission region. Furthermore, an accelerating electrode (or an anode electrode) is formed on the second substrate such that the electrons emitted from the electron emission region at the first substrate are effectively accelerated toward the phosphor layers at the second substrate. In operation, the surface of the second substrate with the phosphor layers is kept at a high potential.

With some electron emission devices the electrons emitted from the electron emission region are diffused toward the second substrate at an angle, and are liable to strike incorrect color phosphors at irrelevant pixel neighbors. Furthermore, when an arc discharge is made within the vacuum vessel for the device, the structural components formed on the first substrate are liable to be damaged due to the arc discharge. In this connection, a structure where a grid electrode is disposed between the first and the second substrates has been proposed to focus the electrons, and prevent the first substrate from being damaged due to the arc discharge.

When electron emission regions are arranged at the pixel regions established on the first substrate, the grid electrode has a plurality of electron beam passage holes corresponding to the pixel regions. The grid electrode is placed between the first and the second substrates while being spaced apart from the latter by spacers.

With the conventional electron emission device, when the grid electrode is aligned to the first substrate, the alignment is arbitrarily made such that the beam passage holes are placed over the electron emission regions. That is, when viewed from the plan side, the electron emission regions are placed within the beam passage holes.

When the electron emission device is driven upon application of external voltages, the electrons emitted from the electron emission regions pass through the beam passage holes of the grid electrode, and land on the phosphor layers at the relevant pixels. However, some of the electrons collide against the grid electrode, and are intercepted thereby or scattered. The scattered electrons land on incorrect phosphor layers at irrelevant pixel neighbors, and excite them.

Consequently, with the conventional electron emission device, the light emission fidelity of the pixels is deteriorated, and the incorrect color phosphor layers are excited to emit light, resulting in poor color representation and screen quality.

### SUMMARY OF THE INVENTION

In one exemplary embodiment of the present invention, there is provided an electron emission device which optimizes the positional relation of the electron emission region to the beam passage hole of the grid electrode to thereby enhance the screen brightness and the color representation.

In an exemplary embodiment of the present invention, an electron emission device includes first and second substrates facing each other with long and short axes, and first and second electrodes formed on the first substrate. Electron emission regions contact the second electrodes, and are located corresponding to pixel regions established on the first substrate. A grid electrode is disposed between the first and the second substrates, and has a plurality of electron beam passage holes corresponding to the respective electron emission regions, and bridges placed between the beam passage holes. When viewed from the plan side, the electron emission region is spaced apart from the geometrical center of the beam passage hole in the short axial direction of the first substrate with a distance of δ, and the distance of δ satisfies any one of the following formulas 1 and 2:

$$\begin{matrix}max ( - \frac{{P}_{υ}}{2} , - \frac{{P}_{υ}}{2} + \frac{{W}_{s}}{2} ) \leq δ \leq - \frac{189 {P}_{υ} ( g + t )}{500 ( {P}_{υ} - b )} \sqrt{\frac{{V}_{gk}}{{V}_{mk}}} & ( 1 ) \\ + \frac{111 {P}_{υ} ( g + t )}{500 ( {P}_{υ} - b )} \sqrt{\frac{{V}_{gk}}{{V}_{mk}}} \leq δ \leq min ( + \frac{{P}_{υ}}{2} , + \frac{{P}_{υ}}{2} - \frac{{W}_{s}}{2} ) & ( 2 )\end{matrix}$$

where Pv indicates the pixel pitch in the short axial direction of the first substrate, Ws the width of a support for the supporting the grid electrode in the short axial direction of the first substrate, g the distance between the first substrate and the grid electrode, t the thickness of the grid electrode, b the length of the bridge between the beam passage holes in the short axial direction of the first substrate, Vgk the potential difference between the first and the second electrodes, Vmk the potential difference between the second electrode and the grid electrode, Pv, Ws, g, t and b are all based on the unit of μm, Vgk and Vmk are all based on the unit of V, the positive (+) direction indicating a direction from the center of the second electrode toward the electron emission regions, the negative (−) direction being the direction opposite to the positive direction, and the supports are disposed between the first substrate and the grid electrode to support the grid electrode.

The electron emission region has an edge, and the distance of δ is defined as the distance of the edge to the geometrical center of the beam passage hole.

The beam passage hole of the grid electrode has a long side proceeding in the short axial direction of the first substrate, and a short side proceeding in the long axial direction of the first substrate.

When the distance δ of the electron emission region to the geometrical center of the beam passage hole satisfies the condition of the formula 2, the electron emission region functionally corresponds to the beam passage hole being placed next to the beam passage hole over the electron emission region in the positive (+) direction.

### BRIEF DESCRIPTION OF THE DRAWINGS

FIG. 1 is a partial exploded perspective view of an electron emission device according to an embodiment of the present invention.

FIG. 2 is a partial sectional view of the electron emission device shown in FIG. 1, illustrating the combinatorial state thereof.

FIG. 3 is a partial amplified view of the electron emission device shown in FIG. 2.

FIGS. 4 and 5 schematically illustrate the positional relation of an electron emission region to an electron beam passage hole of a grid electrode.

FIG. 6 is a graph illustrating the brightness characteristic as a function of the distance of the electron emission region to the beam passage hole.

FIG. 7 is a graph illustrating the color representation as a function of the distance of the electron emission region to the beam passage hole.

FIG. 8 is a photograph of a light emission pattern of a phosphor layer when the distance of the electron emission region to the beam passage hole satisfies the pre-determined condition.

FIG. 9 is a photograph of a light emission pattern of a phosphor layer when the distance of the electron emission region to the beam passage hole does not satisfy the pre-determined condition.

FIG. 10 schematically illustrates the trajectory of electron beams when the distance of the electron emission region to the beam passage hole does not satisfy the pre-determined condition.

### DETAILED DESCRIPTION

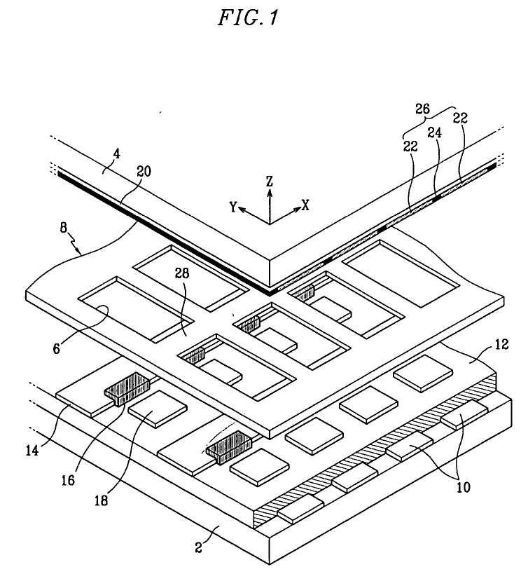

Referring to FIGS. 1-3, an exemplary embodiment of the electron emission device in accordance with the present invention includes first and second substrates 2 and 4 facing each other at a predetermined distance therebetween while forming a vacuum vessel, and grid electrode 8 disposed between first and second substrate 2, 4 with a plurality of electron beam passage holes 6. A structure for emitting electrons is provided at first substrate 2, and a structure for emitting visible rays resulting from the electron emission to display a desired image is provided at second substrate 4

Specifically, a plurality of first electrodes 10 (referred to hereinafter as the “gate electrodes”) are formed on first substrate 2 in a stripe pattern while being spaced apart from each other at a predetermined distance therebetween, and proceeding in the short axial direction of first substrate 2 (in the Y axial direction of the drawing). Insulating layer 12 is formed on the entire inner surface of first substrate 2 while covering gate electrodes 10. A plurality of second electrodes 14 (referred to hereinafter as the “cathode electrodes”) are formed on insulating layer 12 in a stripe pattern while being spaced apart from each other at a predetermined distance, and proceeding in the long axial direction of first substrate 2 (in the X axial direction of the drawing).

Electron emission regions 16 are provided at cathode electrodes 14, and contact the cathode electrodes 14 such that they are electrically connected thereto. Electron emission regions 16 may correspond to the pixel regions established on first substrate 2, respectively. In this embodiment, when the pixel regions are defined as being at the crossed regions of gate and cathode electrodes 10, 14, electron emission regions 16 may be formed on the one-sided peripheries of cathode electrodes 14 at the respective pixel regions.

Electron emission region 16 is formed with a material emitting electrons under the application of an electric field, such as carbon nano tube, graphite, graphite nano fiber, diamond, diamond-like carbon, C₆₀, nano-wire or a mixture thereof, using the technique of screen printing, chemical vapor deposition (CVD) or sputtering. Electron emission region 16 is placed on the top and the lateral sides of cathode electrode 14, and has edge 16a corresponding to the periphery of the cathode electrode.

Counter electrodes 18 are formed on first substrate 2 to elevate the electric field of gate electrode 10 over insulating layer 12. The counter electrodes contact gate electrodes 10 through via holes 12a formed at insulating layer 12 while being electrically connected thereto, and are spaced apart from the electron emission regions 16 at a predetermined distance between cathode electrode neighbors 14.

When predetermined driving voltages are applied to cathode electrode 14 and gate electrode 10 to form an electric field around electron emission region 16, counter electrode 18 additionally directs the electric field toward electron emission region 16. As with electron emission regions 16, counter electrodes 18 may correspond to the pixel regions established on first substrate 2.

Anode electrode 20 is formed on the surface of second substrate 4 facing first substrate 2, and phosphor screen 26 is formed on anode electrode 20 with red, green and blue phosphor layers 22, and light absorbing layer 24. Anode electrode 20 is formed with a transparent material, such as indium tin oxide (ITO). Also, a metallic layer (not shown) may be formed on phosphor screen 26 to enhance the screen brightness due to the metal back effect thereof. In this case, the transparent electrode may be omitted while using the metallic layer as an anode electrode.

Grid electrode 8 is placed between first and second substrates 2, 4 with a plurality of electron beam passage holes 6. Each beam passage hole 6 is rectangular-shaped with a long side proceeding in the short axial direction of first substrate 2 (in the Y axial direction of the drawing), and a short side proceeding in the long axial direction of first substrate 2 (in the X axial direction of the drawing). Bridges 28 are formed between beam passage holes 6 arranged in the short axial direction of first substrate 2.

Grid electrode 8 is spaced apart from first substrate 2 by interposing lower supports 30, and from second substrate 4 by interposing upper supports 32. Grid electrode 8 is placed within the vacuum vessel. The upper and the lower supports are omitted in FIG. 1 for convenience in illustration.

With the above-structured electron emission device, in operation, predetermined voltages are applied to gate electrodes 10, cathode electrodes 14, grid electrode 8 and anode electrode 20 from the outside. For instance, several to several tens volts of positive (+) voltage is applied to gate electrodes 10, several to several tens volts of minus (−) voltage to cathode electrodes 14, several tens to several hundreds volts of positive (+) voltages to grid electrode 8, and several hundreds to several thousands volts of positive (+) voltages to anode electrode 20.

Consequently, an electric field is formed around electron emission region 16 due to the voltage difference between gate and cathode electrodes 10, 14 so that electrons are emitted from electron emission region 16, and directed toward second substrate 4 through beam passage holes 6 of grid electrode 8. At this time, the electrons proceed toward second substrate 4 with a trajectory inclined at an angle. The electrons which pass through electron beam passage holes 6 are attracted by the high voltage applied to anode electrode 20, and hit and excite phosphor layers 22 at the relevant pixels to emit light, and display the desired image.

With the electron emission device according to the embodiment of the present invention, the positional relation of electron emission region 16 to the beam passage hole of grid electrode 8 is made in a proper manner, and the electrons emitted from the electron emission region 16 completely pass through beam passage hole 6 of grid electrode 8, thereby enhancing the screen brightness and the color representation.

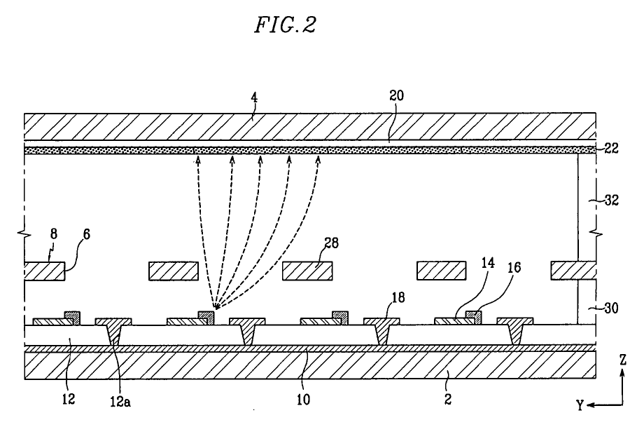

FIG. 3 is a partial amplified view of the electron emission device shown in FIG. 2. As shown in FIG. 3, electron emission region 16 is spaced apart from the center of beam passage hole 6 (indicated by the A line to represent the geometrical center) in the short axial direction of the first substrate (in the Y axial direction of the drawing) at predetermined distance δ. Particularly, edge 16a of electron emission region 16, which takes the main electron emitting role under the strong application of the electric field, is spaced apart from the center of electron emission region 6 at the predetermined distance. In the drawing, the y direction from the center of the cathode electrode 14 (indicated by the B line) toward the electron emission region 16 is determined as the positive (+) direction, and the y direction opposite to the positive direction is determined as the negative (−) direction.

Furthermore, the short axial direction of the first substrate (the Y axial direction of the drawing) is defined as the vertical direction of the screen. In the drawing, Pv indicates the vertical pitch of the pixel, and Ws indicates the vertical width of lower support 30. Furthermore, g indicates the distance between first substrate 2 and grid electrode 8, which is conveniently measured by the distance between grid electrode 8 and insulating layer 12, or the height of lower support 30. The thickness of grid electrode 8 is indicated by t, and the vertical length of bridge 28 by b. It is illustrated in FIG. 3 that the center of respective pixels arranged in the short axial direction of the first substrate 2 corresponds to the center of beam passage holes 6.

The distance δ of electron emission region 16 to the center of beam passage hole 6 is established to satisfy any one of the following formulas 1 and 2:

$$\begin{matrix}max ( - \frac{{P}_{υ}}{2} , - \frac{{P}_{υ}}{2} + \frac{{W}_{s}}{2} ) \leq δ \leq - \frac{189 {P}_{υ} ( g + t )}{500 ( {P}_{υ} - b )} \sqrt{\frac{{V}_{gk}}{{V}_{mk}}} & ( 1 ) \\ + \frac{111 {P}_{υ} ( g + t )}{500 ( {P}_{υ} - b )} \sqrt{\frac{{V}_{gk}}{{V}_{mk}}} \leq δ \leq min ( + \frac{{P}_{υ}}{2} , + \frac{{P}_{υ}}{2} - \frac{{W}_{s}}{2} ) & ( 2 )\end{matrix}$$

where Vgk indicates the potential difference between cathode electrode 14 and gate electrode 10, and Vmk indicates the potential difference between grid electrode 8 and cathode electrode 14.

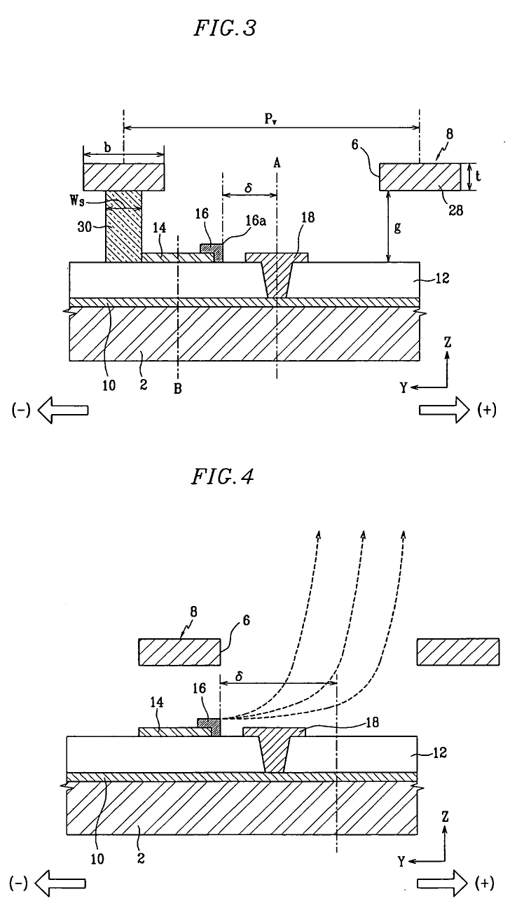

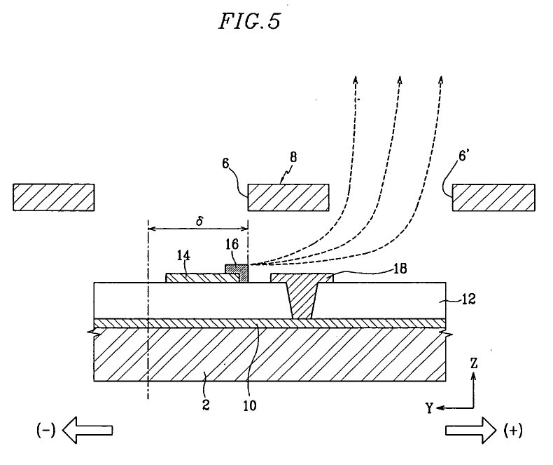

As shown in FIG. 4, electron emission region 16 satisfying the condition of the formula 1 is spaced apart from the center of beam passage hole 6 in the negative (−) direction, and electrons emitted from the electron emission region 16 completely pass through beam passage hole 6, and proceed toward the second substrate (not shown).

As shown in FIG. 5, electron emission region 16 satisfying the condition of the formula 2 is spaced apart from the center of beam passage hole 6 in the positive (+) direction, and the electrons emitted from electron emission region 16 completely pass through beam passage hole 6′ placed next to beam passage hole 6 over electron emission region 16 in the positive (+) direction, and proceed toward the second substrate (not shown).

In relation to the specific contents of the formula 1, assuming that electron emission region 16 and beam passage hole 6 are placed within each pixel region, the maximum distance of electron emission region 16 to the center of beam passage hole 6 does not exceed ½ of vertical pixel pitch Pv. With the pixels mounting lower support 30 thereon, width Ws of lower support 30 should be considered. Accordingly, the maximum distance of electron emission region 16 to the center of beam passage hole 6 can be defined as the left side of the formula 1. Similarly, as shown in FIG. 5, when electron emission region 16 is spaced apart from the center of beam passage hole 6 in the positive (+) direction, the maximum distance of electron emission region 16 to the center of beam passage hole 6 is defined as the right side of the formula 2.

The minimum distance of electron emission region 16 to the center of beam passage hole 6 defined at the formulas 1 and 2 is based on the results of the experiments, in which the brightness characteristic of the screen and the color representation compared to a P22 phosphor were tested while varying the position of electron emission region 16.

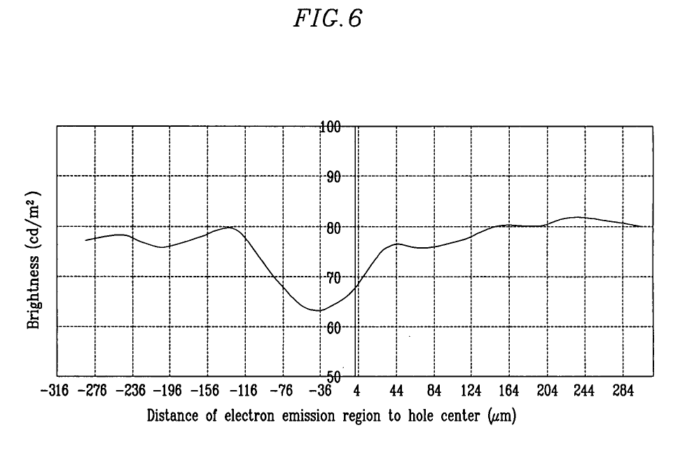

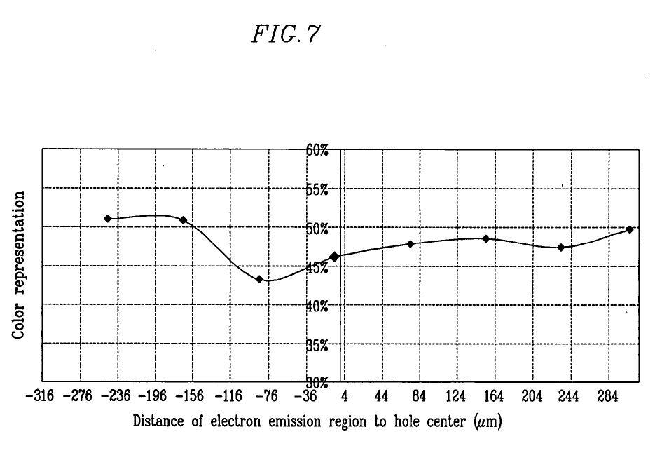

FIGS. 6 and 7 are graphs illustrating the screen brightness characteristic per the distance of the electron emission region to the center of the beam passage hole, and the color representation compared to the P22 phosphor. The experiments were made under the condition that Pv=632 μm, g=200 μm, t=100 μm, and b=63.2 μm. Furthermore, −80V was applied to the cathode electrode, 70V to the gate electrode, 70V to the grid electrode, and 4 kV to the anode electrode.

As shown in FIG. 6, the screen brightness is lowest when the distance δ of the electron emission region to the center of the beam passage hole is in the range of −126 μm to −34 μm. That is, the brightness characteristic is deteriorated in that range. As shown in FIG. 7, the color representation of the screen is lowered to be less than 47% when the distance δ of the electron emission region to the center of the beam passage hole is in the range of −126 μm to −74 μm. That is, the color representation is deteriorated in that range. It is estimated that such results were obtained because when the distance δ of the electron emission region to the center of the beam passage hole is in that range, many of the electrons emitted from the electron emission region 16 collide against bridge 28 of grid electrode 8, and hence, are intercepted thereby or scattered.

In consideration of the previously-described experimental results, the right side of the formula 1 indicating the minimum distance of electron emission region 16 to the center of beam passage hole 6 simplifies the following formula 3 where the correction coefficient is applied to the above experimental results such that the distance g between the first substrate and the grid electrode and the thickness t of the grid electrode are varied, and the vertical aperture ratio of grid electrode 8 and the voltage applied to cathode electrode 14, gate electrode 10 and grid electrode 8 are varied:

$$- 126 \times \frac{( g + t )}{300} \times \frac{0.9 {P}_{υ}}{{P}_{υ} - b} \times \sqrt{\frac{{V}_{gk}}{{V}_{mk}}} . \qquad ( 3 )$$

In the above formula 3,

$$\frac{( g + t )}{300}$$

is the correction coefficient for accommodating the structures where g and t are varied. When the values of g and t are reduced, the desirable location range of electron emission region 16 is extended toward the center of beam passage hole 6.

In this embodiment, the vertical aperture ratio

$$\frac{{P}_{υ} - b}{{P}_{υ}}$$

of grid electrode 8 is 90%, and

$$\frac{0.9 {P}_{υ}}{{P}_{υ} - b}$$

in the above formula 3 is the correction coefficient for accommodating the structures where the vertical aperture ratio of grid electrode 8 is varied. When the length b of bridge 28 is extended while reducing the vertical aperture ratio, the desirable location range of electron emission region 16 is further narrowed as it goes far from the center of beam passage hole 6.

Finally,

$$\sqrt{\frac{{V}_{gk}}{{V}_{mk}}}$$

is the correction coefficient for accommodating the voltage variations. With the structure where gate electrode 10 is placed under cathode electrode 14 while interposing insulating layer 12, as the potential difference Vgk between the cathode and the gate electrodes becomes greater, the electrons are flying further horizontally so that the desirable location range of electron emission region 16 is narrowed as electron emission region 16 goes far from the center of beam passage hole 6. By contrast, when the potential difference Vmk between the cathode electrode and the grid electrode becomes greater, the electrons are flying further vertically toward second substrate 4 so that the desirable location range of the electron emission region 16 is extended toward the center of beam passage hole 6. As the distance δ of electron emission region 16 to the center of beam passage hole 6 and g are in proportion to the value of electric field, they are proportional to the square root value of voltage. The previously described correction coefficient is used to correct such a voltage variation relation.

Similarly, the left side of the formula 2 indicating the minimum distance of electron emission region 16 to the center of beam passage hole 6 simplifies the following formula 4 where the correction coefficient is applied to the above experimental results such that the values of g and t are varied, and the vertical aperture ratio of grid electrode 8 and the voltage applied to cathode electrode 14, gate electrode 10 and grid electrode 8 are varied:

$$+ 74 \times \frac{( g + t )}{300} \times \frac{0.9 {P}_{υ}}{{P}_{υ} - b} \times \sqrt{\frac{{V}_{gk}}{{V}_{mk}}} . \qquad ( 4 )$$

In the formulas 1 to 4, δ, g, Pv, b, t and Ws are all based on the unit of μm, and Vgk and Vmk are all based on the unit of V.

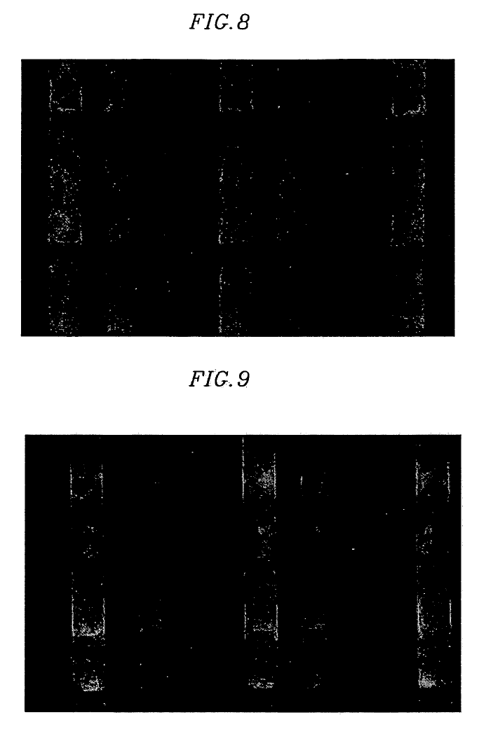

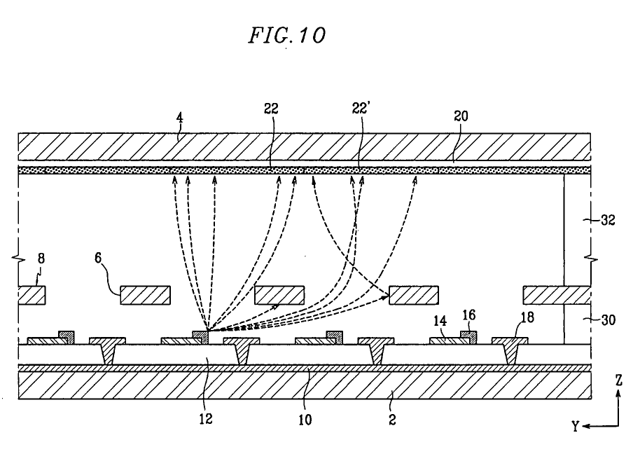

FIG. 8 is a photograph of a light emission pattern of a phosphor layer when the distance of the electron emission region to the center of the beam passage hole satisfies the condition of the formula 1 (δ=−286 μm). FIG. 9 is a photograph of a light emission pattern of a phosphor layer when the distance of the electron emission region to the center of the beam passage hole does not satisfy the condition of the formulas 1 and 2 (δ=−6 μm). FIG. 10 is a schematic view illustrating the expected trajectory of the electron beams. The dimensions and voltage characteristics of the electron emission device used in the experiments were established to be the same as those related to the previously described experiments of testing the brightness characteristic and the color representation.

As shown in FIG. 8, when the distance δ of the electron emission region to the center of the beam passage hole satisfies the condition of the formula 1, the electrons emitted from the electron emission region completely hit the target phosphors at the relevant pixels, thereby expressing excellent light emission fidelity.

By contrast, as shown in FIG. 9, when the distance δ of the electron emission region to the center of the beam passage hole does not satisfy the condition of the formulas 1 and 2, the electrons emitted from the electron emission region do not completely hit the target phosphors at the relevant pixels, thereby expressing poor light emission fidelity. That is, as shown in FIG. 10, many of the electrons emitted from electron emission region 16 collide against grid electrode 8, and are intercepted thereby or scattered. The scattered electrons partially hit incorrect color phosphor layers 22′ at the irrelevant pixel neighbors to thereby light-emit them, not correct phosphor layers 22 at the relevant pixels.

As described above, with the electron emission device according to the embodiment of the present invention, the positional relation of electron emission region 16 to beam passage hole 6 of grid electrode 8 is made in a proper manner so that the electrons emitted from the electron emission region 16 is prevented from colliding against grid electrode 8 and being deviated from the trajectory thereof. Consequently, the brightness characteristic of the screen and the color representation are enhanced with high screen quality.

Although exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

1. An electron emission device comprising:
a first substrate and a second substrate facing each other and each having a corresponding long axis and a corresponding short axis;
first electrodes and second electrodes formed on the first substrate;
electron emission regions at least partially contacting the second electrodes and located corresponding to pixel regions established on the first substrate; and
a grid electrode disposed between the first substrates and the second substrates, and having a plurality of electron beam passage holes corresponding to the respective electron emission regions, and bridges placed between the beam passage holes;
wherein the electron emission region is spaced apart from a geometrical center of the beam passage hole in a short axial direction of the first substrate with a distance of δ, the distance of δ satisfing either one of the following formulas 1 and 2:
$$\begin{matrix}max ( - \frac{{P}_{υ}}{2} , - \frac{{P}_{υ}}{2} + \frac{{W}_{s}}{2} ) \leq δ \leq - \frac{189 {P}_{υ} ( g + t )}{500 ( {P}_{υ} - b )} \sqrt{\frac{{V}_{gk}}{{V}_{mk}}} & ( 1 ) \\ + \frac{111 {P}_{υ} ( g + t )}{500 ( {P}_{υ} - b )} \sqrt{\frac{{V}_{gk}}{{V}_{mk}}} \leq δ \leq min ( + \frac{{P}_{υ}}{2} , + \frac{{P}_{υ}}{2} - \frac{{W}_{s}}{2} ) & ( 2 )\end{matrix}$$
where Pv indicates the pixel pitch in the short axial direction of the first substrate, Ws the width of a support in the short axial direction of the first substrate, g the distance between the first substrate and the grid electrode, t the thickness of the grid electrode, b the length of a bridge between the beam passage holes in the short axial direction of the first substrate, Vgk the potential difference between the first electrodes and the second electrodes, Vmk the potential difference between the second electrode and the grid electrode, Pv, Ws, g, t and b are all based on the unit of μm, Vgk and Vmk are all based on the unit of V, the positive (+) direction indicating a direction from the center of the second electrode toward the electron emission region, the negative (−) direction being the direction opposite to the positive direction, and the supports are disposed between the first substrate and the grid electrode to support the grid electrode.

2. The electron emission device of claim 1, wherein the electron emission region has an edge, and the distance of δ is defined as the distance of the edge to the geometrical center of the beam passage hole.

3. The electron emission device of claim 1, wherein the beam passage hole of the grid electrode has a long side proceeding in the short axial direction of the first substrate, and a short side proceeding in the long axial direction of the first substrate.

4. The electron emission device of claim 1, wherein when the distance δ of the electron emission region to the geometrical center of the beam passage hole satisfies the condition of the formula 2, the electron emission region functionally corresponds to the beam passage hole being placed next to the beam passage hole over the electron emission region in the positive (+) direction.

5. The electron emission device of claim 1, wherein the first electrodes and the second electrodes are insulated from each other by an insulating layer.

6. The electron emission device of claim 5, wherein the first electrode, the insulating layer and the second electrode are sequentially formed on the first substrate, and the first electrodes and the second electrodes are stripe-patterned and perpendicular to each other.

7. The electron emission device of claim 6, wherein the electron emission region is formed on the one-sided periphery of the second electrode at each crossed region of the first electrodes and the second electrodes.

8. The electron emission device of claim 6, further comprising a counter electrode electrically connected to the first electrode, and spaced apart from the electron emission region at a predetermined distance between the second electrodes.

9. The electron emission device of claim 1, wherein the electron emission region comprises at least one material selected from the group consisting of graphite, graphite nano fiber, diamond, diamond-like carbon, carbon nano tube, C₆₀, and nano-wire.

10. The electron emission device of claim 1, further comprising an anode electrode formed on the second substrate, and phosphor layers formed on the anode electrode.
